(19) United States
(12) Patent Application Publication
(10) Pub. No.: US 2025/0291876 A1
(43) Pub. Date: Sep. 18, 2025

(54) ACCELERATOR AND OPERATION METHOD USING THE SAME

(71) Applicants: SAMSUNG ELECTRONICS CO., LTD., SUWON-SI (KR); Seoul National University R&DB Foundation, Seoul (KR)

(72) Inventors: JAEWOONG SIM, Seoul (KR); JUNGI LEE, Seoul (KR); WONBEOM LEE, Seoul (KR)

(21) Appl. No.: 19/041,141

(22) Filed: Jan. 30, 2025

(30) Foreign Application Priority Data
Mar. 15, 2024 (KR) 10-2024-0036408

(51) Int. Cl. G06F 17/16

(52) U.S. Cl. CPC G06F 17/16

(57) ABSTRACT

An accelerator and an operation method using the same are provided. The operation method includes generating first multiply-accumulate (MAC) operation results by performing MAC operations between first quantized activation values quantized from first activation values of a first group in a first size range and first quantized weight values quantized from first weight values forming operation pairs with the first activation values, generating first accumulation results based on the first MAC operation results, rescaling the first accumulation results based on a relationship between scale factors used to quantize an activation dataset including the first activation values and generating first rescaled accumulation results, generating second MAC operation results by performing MAC operations between second quantized activation values quantized from second activation values of a second group in a second size range and second quantized weight values quantized from second weight values forming operation pairs with the second activation values, generating second accumulation results based on the first rescaled accumulation results and the second MAC operation results, and generating an operation result between the activation dataset including the first activation values and the second activation values and a weight dataset including the first weight values and the second weight values, based on the second accumulation results.

### CROSS-REFERENCE TO RELATED APPLICATIONS

This application claims priority under 35 U.S.C. § 119 from Korean Patent Application No. 10-2024-0036408, filed on Mar. 15, 2024 in the Korean Intellectual Property Office, the contents of which are herein incorporated by reference in their entirety.

### TECHNICAL FIELD

One or more embodiments relate to an accelerator and an operation method using the same.

### DISCUSSION OF THE RELATED ART

A vector matrix multiplication operation, also known as a multiply-accumulate (MAC) operation, may influence the performance of an application in various fields. For example, the MAC operation may be performed for machine learning and authentication of a neural network including multiple layers. An input signal may be considered to form an input vector, and be data of images, byte streams, or other data sets. An input signal may be multiplied by a weight, and an output vector may be obtained from a result of accumulated MAC operations. The output vector may be provided as an input vector for a subsequent layer. Since the MAC operation as above is repeated for multiple layers, the neural network processing performance may be mainly determined by the performance of the MAC operation. The MAC operation may be accelerated using various hardware accelerators.

### SUMMARY

According to an aspect, there is provided an operation method of an accelerator, the operation method including generating first multiply-accumulate (MAC) operation results by performing MAC operations between first quantized activation values that are quantized from first activation values of a first group in a first size range and first quantized weight values that are quantized from first weight values forming operation pairs with the first activation values, generating first accumulation results based on the first MAC operation results, rescaling the first accumulation results based on a relationship between scale factors used to quantize an activation dataset including the first activation values and generating first rescaled accumulation results, generating second MAC operation results by performing MAC operations between second quantized activation values that are quantized from second activation values of a second group in a second size range and second quantized weight values that are quantized from second weight values forming operation pairs with the second activation values, generating second accumulation results based on the first rescaled accumulation results and the second MAC operation results, and generating an operation result between the activation dataset including the first activation values and the second activation values and a weight dataset including the first weight values and the second weight values, based on the second accumulation results.

According to another aspect, there is provided an accelerator including processing elements (PEs), in which the PEs are configured to generate first MAC operation results by performing MAC operations between first quantized activation values that are quantized from first activation values of a first group in a first size range and first quantized weight values that are quantized from first weight values forming operation pairs with the first activation values, generate first accumulation results based on the first MAC operation results, rescale the first accumulation results based on a relationship between scale factors used to quantize an activation dataset including the first activation values and generate first rescaled accumulation results, generate second MAC operation results by performing MAC operations between second quantized activation values that are quantized from second activation values of a second group in a second size range and second quantized weight values that are quantized from second weight values forming operation pairs with the second activation values, generate second accumulation results based on the first rescaled accumulation results and the second MAC operation results, and generate an operation result between the activation dataset including the first activation values and the second activation values and a weight dataset including the first weight values and the second weight values, based on the second accumulation results.

### BRIEF DESCRIPTION OF THE DRAWINGS

FIG. 1 is a schematic diagram illustrating an input, processing, and an output of an accelerator, according to an embodiment;

FIG. 2 is a diagram illustrating an example of a quantization process of an activation dataset, according to an embodiment;

FIG. 3 is a diagram illustrating an example of distribution of maximum absolute values in columns of an activation matrix, according to an embodiment;

FIG. 4 is a diagram illustrating an example of a quantization process of a weight dataset, according to an embodiment;

FIG. 5 is a diagram illustrating an example of a structure of an accelerator, according to an embodiment;

FIG. 6 is a diagram illustrating an example of operations of an accelerator for a predetermined period of time, according to an embodiment;

FIG. 7 is a diagram illustrating an example of an operation of merging rescaled accumulation results, according to an embodiment;

FIGS. 8A to 8D are diagrams illustrating specific examples of an operation of an accelerator, according to an embodiment;

FIG. 9 is a diagram illustrating an example of an accelerator in a weight-stationary type, according to an embodiment;

FIG. 10 is a diagram illustrating an example of a multi-bit rescaling process according to an embodiment;

FIG. 11 is a flowchart illustrating an example of an operation method of an accelerator, according to an embodiment; and

FIG. 12 is a block diagram illustrating an example of a configuration of an electronic device, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “at least one of A and B”, “at least one of A, B, or C,” and the like, each of which may include any one of the items listed together in the corresponding one of the phrases, or all possible combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

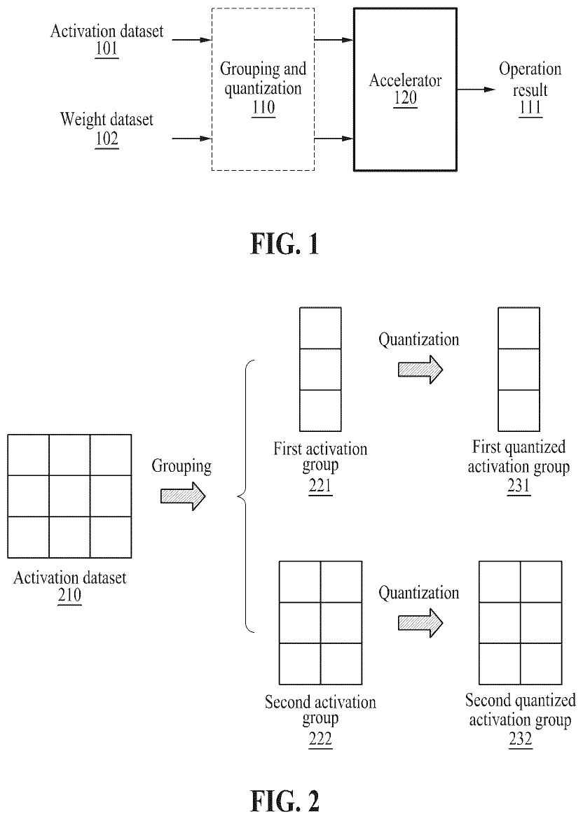

FIG. 1 is a schematic diagram illustrating an input, processing, and an output of an accelerator, according to an embodiment. Referring to FIG. 1, grouping and quantization 110 may be performed on an activation dataset 101 and a weight dataset 102. The activation dataset 101 may include input activation values. For example, the activation dataset 101 may be, but is not limited to, an input activation matrix including the input activation values. The weight dataset 102 may include weight values. For example, the weight dataset 102 may be, but is not limited to, a weight matrix including the weight values.

A quantization-based operation can help efficiently process a large model such as a large language model (LLM) by streamlining an operation. Embodiments of the present disclosure can effectively implement a quantization-based operation in terms of a quantization method and an operation method (structure). For example, according to embodiments of the present disclosure, columns of an activation matrix may be grouped based on maximum absolute values of the columns. For example, columns having the largest maximum absolute values can be grouped into a first group, and columns having the smallest maximum absolute values can be grouped into an n-th group. Activation values of each group can be quantized using different scale factors. A predetermined ratio is defined between the scale factors. For example, a scale factor used for quantization of a first group may be twice as large as a scale factor used for quantization of a second group. When a multiply-accumulate (MAC) operation is performed, partial products of groups are accumulated through this ratio-based multiplication operation. For example, when a ratio between scale factors is doubled, a partial product of the first group may be doubled and added to a partial product of the second group. For example, when the ratio is double, a 1-bit shifter can be used instead of a multiplier.

The weight dataset 102 may correspond to a configuration of a neural network, and the activation dataset 101 may correspond to an input of the neural network. An accelerator 120 may generate an operation result 111 by processing a network operation based on the activation dataset 101 and the weight dataset 102. For example, the network operation may include a multiply-accumulate (MAC) operation. Processing the network operation of the neural network may correspond to executing the neural network. The operation result 111 may include output activation values. For example, the operation result 111 may be an output activation matrix including the output activation values. The operation result 111 may correspond to a result derived from a function of the neural network. For example, when the neural network is a recognition model, the operation result 111 may correspond to a recognition result. When the neural network is a large language model (LLM), the operation result 111 may be a natural language processing result.

Quantized activation groups may be determined by performing the grouping and quantization 110 on the activation dataset 101. The grouping and quantization 110 may be performed outside or inside of the accelerator 120. For example, the grouping and quantization 110 may be performed outside of the accelerator 120 by a processor (e.g., a central processing unit (CPU)) that is separate from the accelerator 120. Alternatively, the grouping and quantization 110 may be performed inside of the accelerator 120 by the accelerator 120. In this case, the accelerator 120 may include a processor (e.g., a hardware logic) that performs the grouping and quantization 110.

Each of the quantized activation groups may include quantized activation values. Activation values of the activation dataset 101 may be grouped based on the size range. For example, activation values falling within a first size range may be grouped into a first group and activation values falling within a second size range may be grouped into a second group. The activation values of the first group may be referred to as first activation values, and the activation values of the second group may be referred to as second activation values. The activation values in each size range may be quantized. For example, first quantized activation values that are quantized from the first activation values and second quantized activation values that are quantized from the second activation values may be determined.

The activation dataset 101 may be an input activation matrix. Hereinafter, the input activation matrix may simply be referred to as an activation matrix. Activation values of the activation matrix may be divided according to columns of the activation matrix. The activation values may be grouped according to the size range within which the maximum value of absolute values of the activation values of each column falls. For example, when the maximum value of absolute values of activation values in the first column falls within the first size range, the activation values in the first column may be grouped into the first group, and when the maximum value of absolute values in the second column falls within the second size range, the activation values in the second column may be grouped into the second group.

The activation values and weight values may form operation pairs based on a predetermined operation rule between the activation dataset 101 and the weight dataset 102. For example, the activation values and weight values may form operation pairs for a matrix product when the matrix product is required between the activation matrix of the activation dataset 101 and the weight matrix of the weight dataset 102. When the activation values are grouped, the weight dataset 102 may be grouped depending on the result of grouping the activation values. For example, the activation values may be grouped based on columns of the activation matrix, and the weight values may be grouped based on rows of the weight matrix corresponding to the columns of the activation matrix.

The input activation values of the activation dataset 101 and the weight values of the weight dataset 102 may correspond to a real number format. Hereinafter, the input activation values may simply be referred to as activation values. The quantized activation values and the quantized weight values may correspond to an integer format.

As the scale of neural networks (e.g., LLMs) grows, data quantization may help efficiently process an operation of a neural network. Through quantization, successive values in a real number format may be converted into discrete values in an integer format. Quantization may reduce the number of bits used to express many numbers.

Both the activation values and the weight values may be subject to quantization. When only one of the two is quantized, it may only help in terms of memory bandwidth utilization, but the gain may be small since an operation is performed with high precision.

The weight values of each group may be quantized using a method such as uniform symmetric quantization, etc. The uniform symmetric quantization may be a quantization method that multiplies all weight values of a corresponding group by a scale factor, based on a weight value of which the absolute value of the weight values of each group corresponds to the maximum value. In the activation matrix, there may be a column having a much greater absolute value than other columns. These activation values or columns may be referred to as outliers. According to embodiments, the outliers may be effectively processed through grouping for each size range.

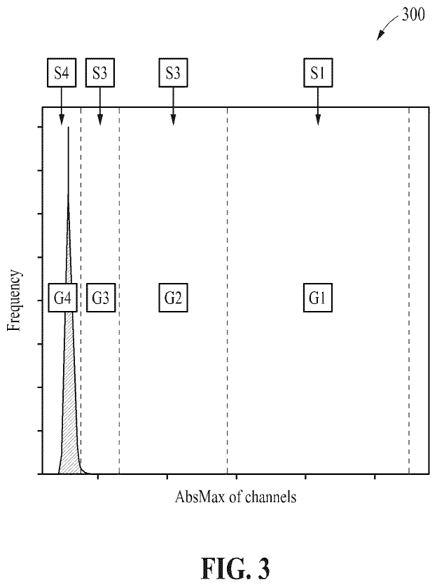

FIG. 2 is a diagram illustrating an example of a quantization process of an activation dataset, according to an embodiment. Referring to FIG. 2, grouping and quantization may be performed on an activation dataset 210. FIG. 2 shows an example in which the activation dataset 210 is a 3*3 activation matrix but is not limited thereto. The activation dataset 210 may be grouped into a first activation group 221 and a second activation group 222 based on the size range of activation values of the activation dataset 210. For example, activation values in the first column may be grouped into the first activation group 221 when the maximum value of absolute values of the activation values in the first column of the activation dataset 210 falls within a first size range. Activation values in the second and third columns may be grouped into the second activation group 222 when the maximum value of absolute values of the activation values in the second and third columns of the activation dataset 210 falls within a second size range. First activation values of the first activation group 221 and second activation values of the second activation group 222 may be different columns of the activation matrix. FIG. 2 shows an example of two activation groups (e.g., the first activation group 221 and the second activation group 222), but embodiments are not limited thereto.

A first quantized activation group 231 may be determined according to quantization on the first activation group 221, and a second quantized activation group 232 may be determined according to quantization on the second activation group 222. The first activation group 221 may include the first activation values, and the first quantized activation group 231 may include first quantized activation values. The second activation group 222 may include the second activation values, and the second quantized activation group 232 may include second quantized activation values. The first activation group 221 and the second activation group 222 may be quantized based on different scale factors.

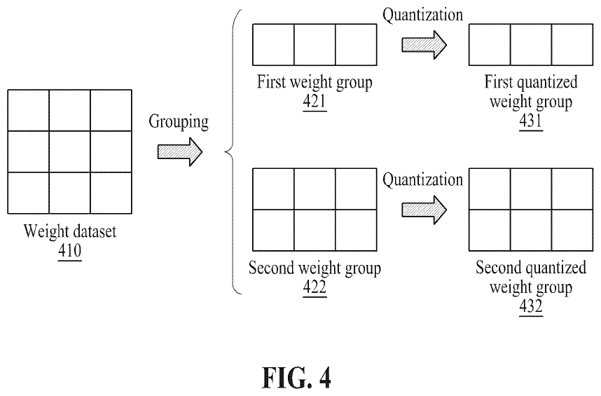

FIG. 3 is a diagram illustrating an example of distribution of maximum absolute values in columns of an activation matrix, according to an embodiment. Referring to FIG. 3, in a graph 300, the horizontal axis may represent the maximum value (hereinafter, referred to as the maximum absolute value) of absolute values of channels, and the vertical axis may represent frequency. The channels may correspond to the columns of the activation matrix. Based on the size range within which the maximum absolute value of the columns of the activation matrix falls, activation values of the columns may be grouped into a first group G1, a second group G2, a third group G3, and a fourth group G4. However, the first to fourth groups G1 to G4 are examples and are not limited thereto.

The first to fourth groups G1 to G4 may be quantized using first to fourth scale factors S1 to S4. For example, quantization may be performed on the first to fourth groups G1 to G4 by dividing activation values of the first to fourth groups G1 to G4 by corresponding values of the first to fourth scale factors S1 to S4. Dequantized values may be obtained by multiplying quantized values by corresponding values when dequantization is performed on the quantized values.

The different first to fourth scale factors S1 to S4 may be applied to the first to fourth groups G1 to G4. The first scale factor S1 may be applied to the first group G1, the second scale factor S2 may be applied to the second group G2, the third scale factor S3 may be applied to the third group G3, and the fourth scale factor S4 may be applied to the group G4. A ratio between the first to fourth scale factors S1 to S4 may be an integer. For example, the third scale factor S3 may be a times the fourth scale factor S4, the second scale factor S2 may be a times the third scale factor S3, and the first scale factor S1 may be α times the second scale factor S2. For example, when quantizing to INT8, the first scale factor S1 may be 28/127, the second scale factor S2 may be 14/127, the third scale factor S3 may be 7/127, and the fourth scale factor S4 may be 3.5/127 but are not limited thereto. α may be based on the relationship between the first to fourth scale factors S1 to S4 and may be referred to as a multiplication factor. For example, the multiplication factor may correspond to the ratio between the first to fourth scale factors S1 to S4. The multiplication factor may be used for rescaling. During an operation, groups may be input to an accelerator starting from a group having a large-scale factor. Although an example in which one a value is used as the multiplication factor is described, different a values may be used as multiplication factors. For example, a ratio between the first scale factor S1 and the second scale factor S2 may be α1, a ratio between the second scale factor S2 and the third scale factor S3 may be α2, a ratio between the third scale factor S3 and the fourth scale factor S4 may be α3, and α1, α2, and α3 may be used for rescaling as the multiplication factors.

As an integer multiple relationship is established between the first to fourth scale factors S1 to S4, a quantization error may be effectively minimized based on distribution of the activation values. In the graph 300, a group having a large-scale factor may include a small number of columns and may be grouped in a coarse manner, while a group having a small-scale factor may include a large number of columns and may be grouped in a fine-grain manner. For example, the maximum absolute value of first activation values of the first group G1 may be greater than the maximum absolute value of second activation values of the second group G2. The first scale factor S1 used to quantize the first activation values may be greater than the second scale factor S2 used to quantize the second activation values. A first size range of the first group G1 may be wider than a second size range of the second group G2. A quantization error of the first to fourth groups G1 to G4 may be proportional to a product of the size of the first to fourth scale factors S1 to S4 and the number of columns of the first to fourth groups G1 to G4. The quantization error may be minimized by applying a scale factor to a group including a small number of columns in the coarse manner and applying a scale factor to a group including a large number of columns in the fine-grain manner.

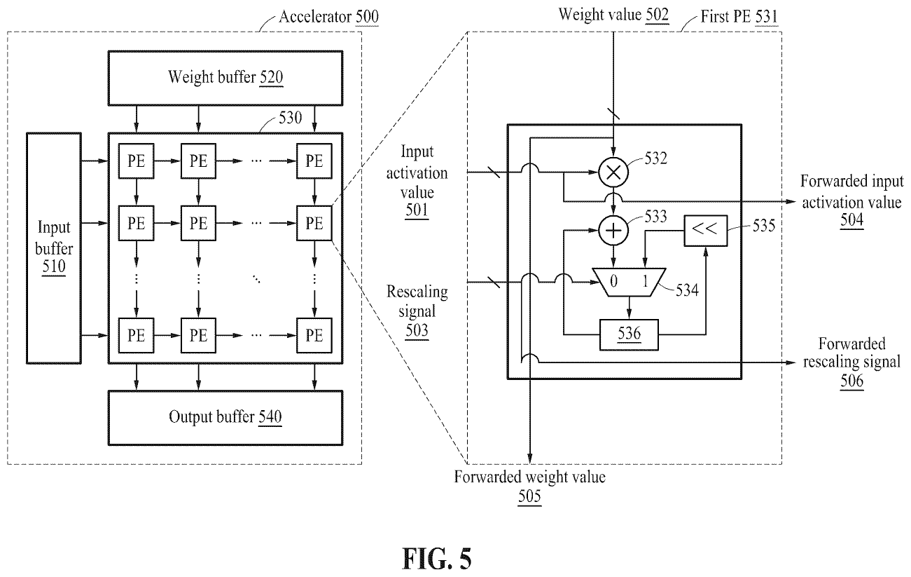

FIG. 4 is a diagram illustrating an example of a quantization process of a weight dataset, according to an embodiment. Referring to FIG. 4, grouping and quantization may be performed on a weight dataset 410. FIG. 4 shows an example in which the weight dataset 410 is a 3*3 weight matrix but is not limited thereto. In the weight dataset 410, weight values may be grouped per-row, per-tensor, or per-column. For example, the weight dataset 410 may be grouped depending on a result of the grouping of activation datasets. First weight values of a first weight group 421 and second weight values of a second weight group 422 may be different rows of a weight matrix. FIG. 4 shows an example of two weight groups (e.g., the first weight group 421 and the second weight group 422) but is not limited thereto.

A first quantized weight group 431 may be determined according to quantization on the first weight group 421, and a second quantized weight group 432 may be determined according to quantization on the second weight group 422. The first weight group 421 may include the first weight values, and the first quantized weight group 431 may include first quantized weight values. The second weight group 422 may include the second weight values, and the second quantized weight group 432 may include second quantized weight values.

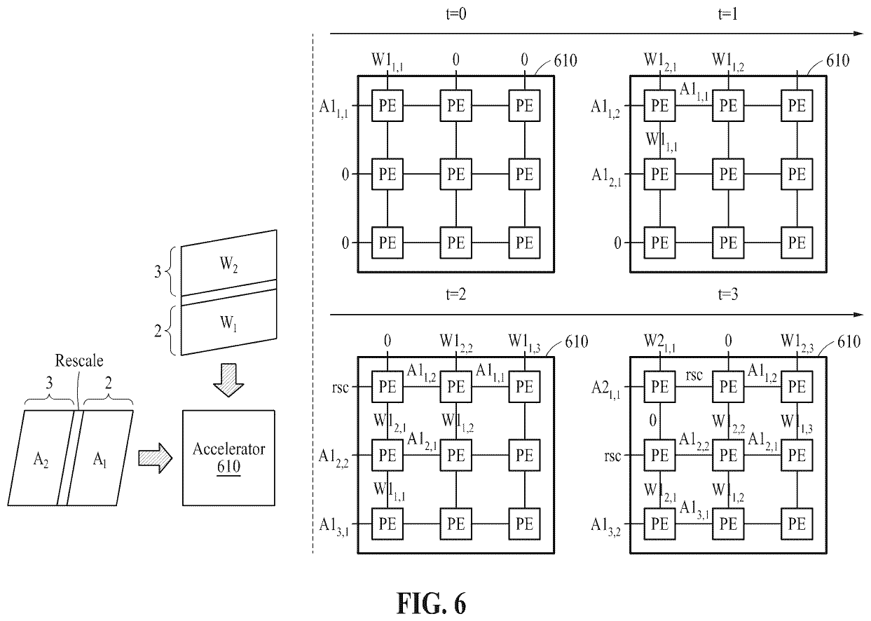

FIG. 5 is a diagram illustrating an example of a structure of an accelerator, according to an embodiment. Referring to FIG. 5, an accelerator 500 may include an input buffer 510, a weight buffer 520, processing elements (PEs) 530, and an output buffer 540. The input buffer 510 and the weight buffer 520 may provide input activation values and weight values to the PEs 530. Input activation values of a group having a large size range (i.e., a group to which a large-scale factor is applied) and weight values forming operation pairs with corresponding input activation values may first be supplied to the PEs 530. The PEs 530 may be, but are not limited to, systolic arrays. The output buffer 540 may store an operation result of the PEs 530. The operation result may include output activation values.

FIG. 5 shows a structure of a first PE 531 of the PEs 530. The remaining PEs of the PEs 530 may have the same structure as the first PE 531. The first PE 531 may include a multiplier 532, an adder 533, a multiplexer (MUX) 534, a 1-bit shifter 535, and an accumulation register 536. FIG. 5 shows an example in which rescaling is performed twice using the 1-bit shifter 535 but is not limited thereto.

The PEs 530 may generate quantized output activation values by processing quantized input activation values. The quantized input activation values may be processed sequentially for each group. For example, processing stages of the quantized input activation values may include a first processing stage that processes first quantized activation values of a first group, a second processing stage that processes second quantized activation values of a second group, a third processing stage that processes third quantized activation values of a third group, and a fourth processing stage that processes fourth quantized activation values of a fourth group. This may correspond to an example in which activation values are grouped into four groups, but embodiments are not limited thereto. The accumulation results of each processing stage may be rescaled based on a relationship between scale factors in the last stage of each processing stage. For example, rescaled accumulation results may be generated by multiplying the accumulation results of each processing stage by a multiplication factor, based on the relationship between the scale factors.

More specifically, in the first processing stage, the PEs 530 may generate first MAC operation results by performing MAC operations between the first quantized activation values and first weight values and may generate first accumulation results based on the first MAC operation results. The first quantized activation values may be quantized from first activation values of the first group in a first size range. The first weight values may form operation pairs with the first activation values. The MAC operation results may be repeatedly generated in each PE according to an input of input activation values to each PE in each processing stage, and the accumulation results may refer to the final version of the MAC operation results to each PE in each processing stage. For example, when p first input activation values are sequentially input to the first PE 531 in the first processing stage, p first MAC operation results may be generated sequentially, and a p-th first MAC operation result may correspond to the first accumulation result. The MAC operation results may be referred to as an intermediate accumulation result, a partial accumulation result, a partial product, or a partial sum, and an accumulation result may be referred to as a final accumulation result.

More specifically, in the first processing stage, the multiplier 532 of the first PE 531 may generate a current multiplication result by performing a multiplication operation between a current input activation value (e.g., an input activation value 501) corresponding to a first input activation value and a current input weight value (e.g., a weight value 502) corresponding to the first weight value. The adder 533 may generate a current MAC operation result by performing an addition operation between the current multiplication result and a previous MAC operation result. The accumulation register 536 may store the current MAC operation result. The current MAC operation result may correspond to the first accumulation result when the current MAC operation result is a final MAC operation result. The 1-bit shifter 535 may perform a shift operation on the first accumulation result. For example, the input activation value 501 and the weight value 502 may be 4 bits, a rescaling signal 503 may be 1 bit, and the accumulation register 536 may be 32 bits but are not limited thereto. The input activation value 501 may be forwarded to the next PE as a forwarded input activation value 504. The weight value 502 may be forwarded to the next PE as a forwarded weight value 505.

When MAC operations of the first input activation values are completed by the PEs 530 so that the first accumulation results of the first processing stage are determined by the PEs 530, the PEs 530 may rescale the first accumulation results and may generate first rescaled accumulation results. For example, the first PE 531 may rescale the first accumulation results based on the rescaling signal 503. For example, the rescaling signal 503 may have a value of 0 or 1. When the rescaling signal 503 has a value of 0, an output of the adder 533 may be selected by the MUX 534 so that the MAC operation results may be accumulated, and when the rescaling signal 503 has a value of 1, an output of the 1-bit shifter 535 may be selected by the MUX 534 so that the first accumulation results may be rescaled.

In the second processing stage, the PEs 530 may generate second MAC operation results by performing MAC operations between the second quantized activation values and second weight values and may generate second accumulation results based on the second MAC operation results. The second quantized activation values may be quantized from second activation values of the second group in a second size range. The second weight values may form operation pairs with the second activation values.

More specifically, in the second processing stage, the multiplier 532 of the first PE 531 may generate a current multiplication result by performing a multiplication operation between a current input activation value (e.g., the input activation value 501) corresponding to a second input activation value and a current input weight value (e.g., the weight value 502) corresponding to the second weight value. The adder 533 may generate a current MAC operation result by performing an addition operation between the current multiplication result and a previous MAC operation result. The accumulation register 536 may store the current MAC operation result.

At the starting point of the second processing stage, the previous MAC operation result may be the first rescaled accumulation result. Here, the adder 533 may perform an addition operation between the current multiplication result and the first rescaled accumulation result. According to repetitive addition operations, the second MAC operation results of the second activation values may be further accumulated in the first rescaled accumulation result. The current MAC operation result may correspond to the second accumulation result when the current MAC operation result is a final MAC operation result. The 1-bit shifter 535 may perform a shift operation on the second accumulation result. When MAC operations of second input activation values are completed by the PEs 530 so that the second accumulation results of the second processing stage are determined by the PEs 530, the PEs 530 may rescale the second accumulation results and may generate second rescaled accumulation results.

When this process is repeated for activation values of all groups, an operation result between an activation dataset including the first input activation values and the second input activation values and a weight dataset including the first weight values and the second weight values may be generated. The operation result may correspond to output activation values.

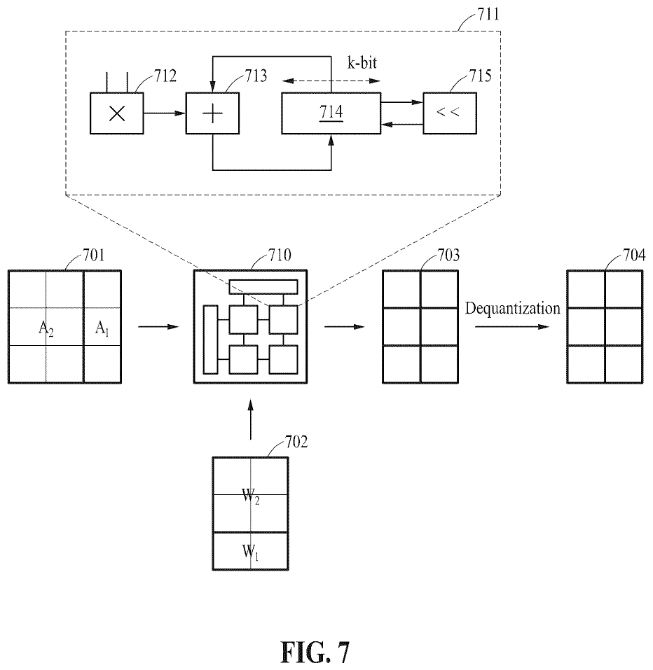

FIG. 6 is a diagram illustrating an example of operations of an accelerator for a predetermined period of time, according to an embodiment. Referring to FIG. 6, an accelerator 610 may generate first accumulation results by performing MAC operations between a first activation group A1 and a first weight group W1 and may rescale the first accumulation results so that first rescaled accumulation results may be generated. The accelerator 610 may generate second accumulation results by performing MAC operations between a second activation group A2 and a second weight group W2 and may accumulate the first rescaled accumulation results and the second accumulation results.

Activation values and weight values may be forwarded to the next processor at every cycle, and MAC operation results (i.e., a partial accumulation result, an intermediate accumulation result, and a partial product) may be continuously accumulated in each processor. A rescaling signal may be forwarded to the next processor like the activation values and the weight values. A rescaling signal rsc may have a value of 0 during a MAC operation and a value of 1 during a rescaling operation. For example, the rescaling signal rsc may have a value of 1 for one cycle after a MAC operation between a current activation group and a current weight group is completed.

FIG. 6 shows PEs in the form of a 3*3 array but is not limited thereto. In the example shown in FIG. 6, the PEs may be identified by (x, y). x and y may each have a value from 1 to 3. In FIG. 6, at t=0, a PE of (1, 1) may perform a MAC operation between an activation value A11,1 of the first activation group A1 and a weight value W11,1 of the first weight group W1. The activation value A11,1 of the first activation group A1 may be transmitted to a PE of (1, 2), and the weight value W11,1 of the first weight group W1 may be transmitted to a PE of (2, 1).

At t=1, the PE of (1, 1) may perform a MAC operation between an activation value A11,2 of the first activation group A1 and a weight value W12,1 of the first weight group W1. The PE of (1, 1) may generate a first accumulation result by accumulating the MAC operation result of t=0 and the MAC operation result of t=1. At t=1, the PE of (1, 2) may perform a MAC operation between the activation value A11, 1 of the first activation group A1 and a weight value W11,2 of the first weight group W1. At t=1, the PE of (2, 1) may perform a MAC operation between an activation value A12,1 of the first activation group A1 and the weight value W11,1 of the first weight group W1. The activation value A11, 1 of the first activation group A1 may be transmitted to a PE of (1, 3), and the weight value W11,1 of the first weight group W1 may be transmitted to a PE of (3, 1). The activation value A11,2 of the first activation group A1 may be transmitted to the PE of (1, 2), and the weight value W12,1 of the first weight group W1 may be transmitted to the PE of (2, 1).

At t=2, the PE of (1, 1) may rescale the first accumulation result based on the rescaling signal rsc having a value of 1 and may generate a first rescaled accumulation result. Here, a bubble in which an activation value or a weight value is not provided may be formed in the PE of (1, 1). At t=2, the PE of (1, 2) may perform a MAC operation between the activation value A11,2 of the first activation group A1 and a weight value W12,2 of the first weight group W1. The PE of (1, 2) may generate the first accumulation result by accumulating the MAC operation result of t=1 and the MAC operation result of t=2. At t=2, the PE of (2, 1) may perform a MAC operation between an activation value A12,2 of the first activation group A1 and the weight value W12,1 of the first weight group W1. The PE of (2, 1) may generate the first accumulation result by accumulating the MAC operation result of t=1 and the MAC operation result of t=2. The rescaling signal rsc having a value of 1 may be transmitted to the PE of (1, 2).

At t=3, the PE of (1, 2) and the PE of (2, 1) may rescale the first accumulation result based on the rescaling signal rsc having a value of 1 and may generate the first rescaled accumulation result.

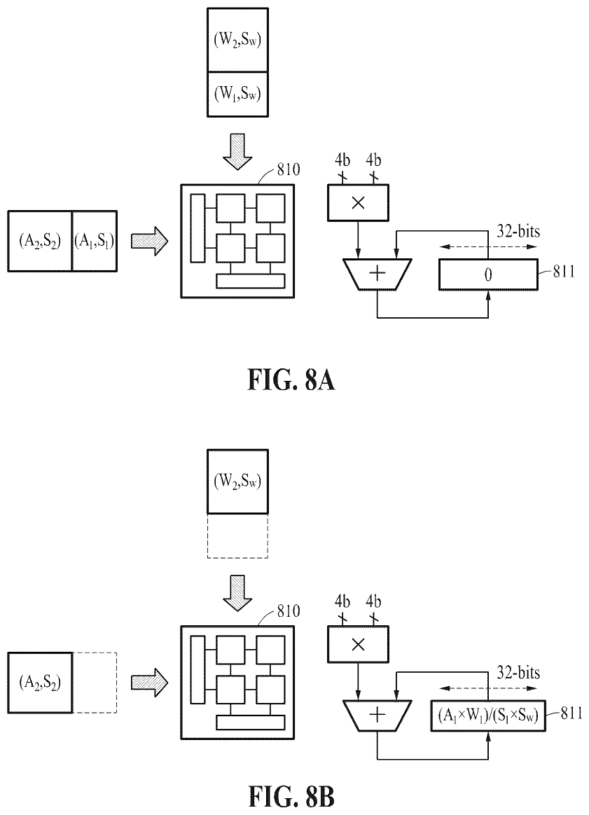

FIG. 7 is a diagram illustrating an example of an operation of merging rescaled accumulation results, according to an embodiment. Referring to FIG. 7, an accelerator 710 may perform a MAC operation between an activation dataset 701 including a first activation group A1 and a second activation group A2 and a weight dataset 702 including a first weight group W1 and a second weight group W2. The activation dataset 701 and the weight dataset 702 may be processed by the accelerator 710 in a quantized state, and a quantized operation result 703 may be generated. An operation result 704 may be generated by dequantization on the quantized operation result 703.

A processor 711 may perform a MAC operation using a multiplier 712, an adder 713, and an accumulation register 714. The accumulation register 714 may be k bits. For example, k may be 32 (i.e., k=32) but is not limited thereto. Explicit quantization and dequantization on individual MAC operation results of the first activation group A1 and the second activation group A2 may be replaced with a shift operation of a 1-bit shifter 715. Since rescaling is performed inside of the processor 711 during a MAC operation, a fast operation speed may be achieved by performing one large matrix product, unlike a method of performing several small matrix products. Additionally, the 1-bit shifter 715, which is a simple hardware module, may be easily and quickly applied to an existing system.

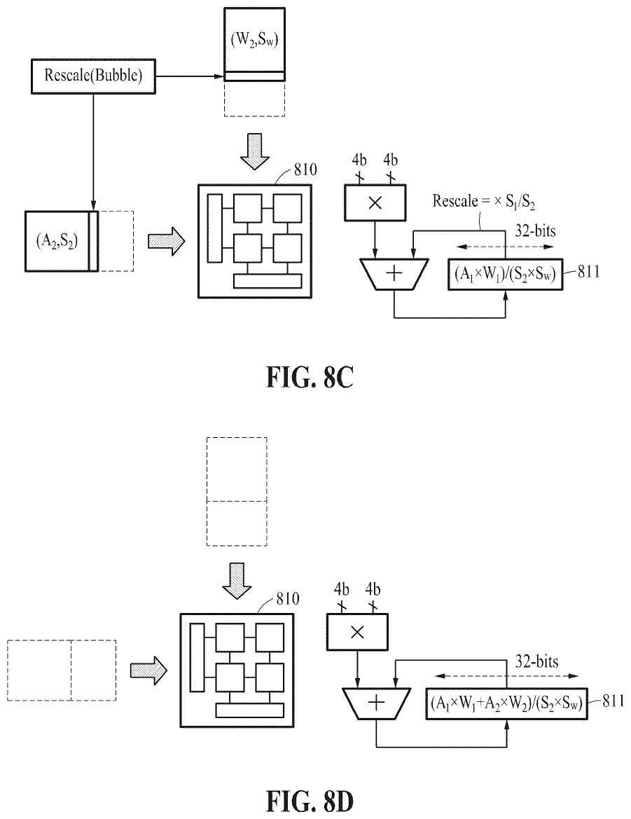

FIGS. 8A to 8D are diagrams illustrating specific examples of an operation of an accelerator, according to an embodiment. FIG. 8A shows an initial state, FIG. 8B shows a MAC operation process between a first activation group A1 and a first weight group W1, FIG. 8C shows a rescaling process for a first accumulation result, and FIG. 8D shows a MAC operation process between a second activation group A2 and a second weight group W2. A first scale factor S1 may be applied to the first activation group A1, a second scale factor S2 may be applied to the second activation group A2, and a common scale factor Sw may be applied to the first and second weight groups W1 and W2. The common scale factor Sw is an example but is not limited thereto. For example, different scale factors, such as a first weight scale factor Sw1 and a second weight scale factor Sw2, may be applied to the first and second weight groups W1 and W2 instead of the common scale factor Sw.

Referring to FIG. 8B, an accelerator 810 may perform a MAC operation between the first activation group A1 and the first weight group W1. First activation values of the first activation group A1 and first weight values of the first weight group W1 may be provided to the accelerator 810 in a quantized state. The accelerator 810 may perform a MAC operation between the first activation values in the quantized state and the first weight values in the quantized state. Here, a rescaling signal may have a value of 0. A first accumulation result, which is the final result of the MAC operation between the first activation group A1 and the first weight group W1, may be expressed as (A1*W1)/(S1*Sw).

Referring to FIG. 8C, the rescaling signal may have a value of 1 for one cycle when the MAC operation between the first activation group A1 and the first weight group W1 is completed and before the MAC operation between the second activation group A2 and the second weight group W2 is performed. Here, a 1-bit shift operation may be performed on the first accumulation result stored in an accumulation register 811. The 1-bit shift operation may be performed by a 1-bit shifter (not shown) of a PE of the accelerator 810. The 1-bit shift operation may correspond to an operation of multiplying by 2, which may be the same as a ratio between the first scale factor S1 and the second scale factor S2, that is, S1/S2. When the first accumulation result is rescaled by the 1-bit shift operation, a first rescaled accumulation result may be expressed as (A1*W1)/(S2*Sw).

Referring to FIG. 8D, the accelerator 810 may perform a MAC operation between the second activation group A2 and the second weight group W2. Second activation values of the second activation group A2 and second weight values of the second weight group W2 may be provided to the accelerator 810 in a quantized state. The accelerator 810 may perform a MAC operation between the second activation values in the quantized state and the second weight values in the quantized state. Here, the rescaling signal may have a value of 0. A second accumulation result, which is the final result of the MAC operation between the second activation group A2 and the second weight group W2, and the first rescaled accumulation result may be accumulated in the accumulation register 811, and as a result, an operation result may be generated. The operation result may be expressed as (A1*W1+A2*W2)/(S2*Sw).

Thereafter, dequantization may be performed by multiplying the operation result by S2*Sw, and a dequantized operation result may be obtained. FIGS. 8A to 8D show examples in which the capacity of the accumulation register 811 is 32 bits, but embodiments are not limited thereto. For example, the size of the accumulation register 811 may have a greater capacity considering information loss.

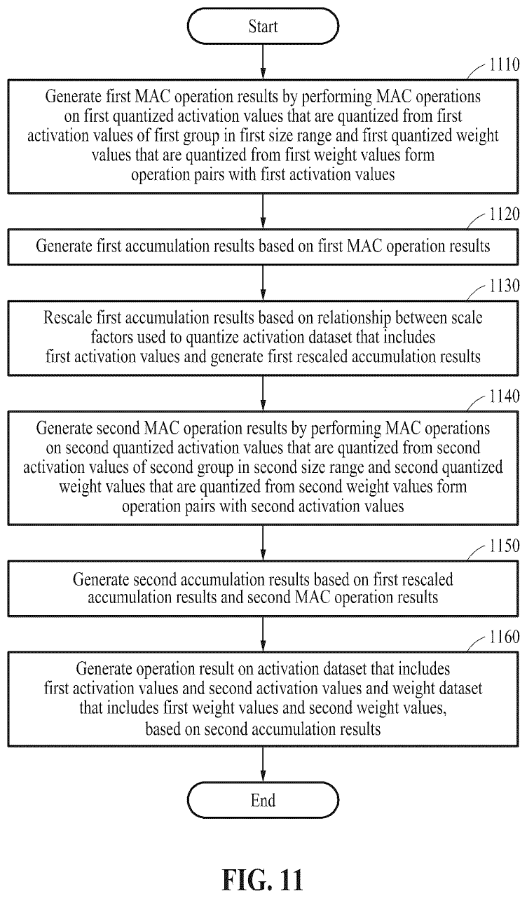

In embodiments, when activation values of an activation dataset are grouped into Z groups, Z cycles corresponding to Z rescaling operations may be added to the overhead. This may correspond to an almost negligible level compared to the total MAC operation time. A ratio between the scale factors may be set to an integer other than 2. As described below with reference to FIG. 11, even in this case, rescaling may be performed using a multiplier of PEs. In this case, the number of cycles required for rescaling may increase, but this may also correspond to an almost negligible level compared to the total MAC operation time.

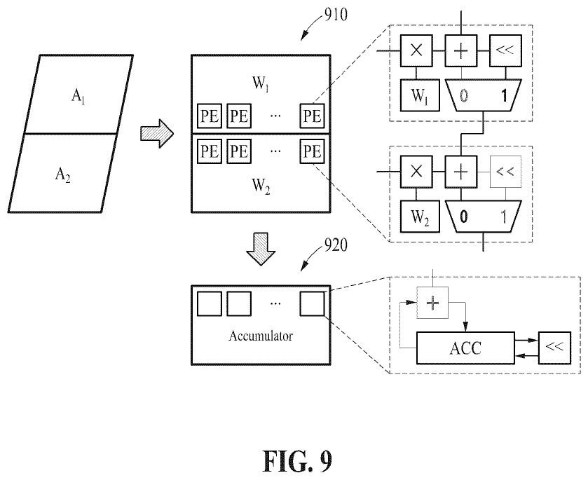

FIG. 9 is a diagram illustrating an example of an accelerator in a weight-stationary type, according to an embodiment. Although an accelerator in an output-stationary type is described above, an accelerator in a weight-stationary type may also be used, as shown in FIG. 9.

Referring to FIG. 9, PEs 910 may store weight values (e.g., first weight values of a first weight group W1 and second weight values of a second weight group W2) before performing a MAC operation. The weight values may be stored according to the operation order. When the MAC operation starts, activation values (e.g., first activation values of the first activation group A1 and second activation values of the second activation group A2) may be input to the PEs 910. The activation values may be transmitted in the row direction. The MAC operation results and accumulation results may be transmitted in the column direction. The MAC operation results and the accumulation results may be accumulated in an accumulator 920. Since the accumulator 920 is configured separately from the PEs 910, a 1-bit shifter may be added to the PEs 910 and the accumulator 920, respectively.

The PEs 910 may be classified according to a weight group. For example, some PEs of the PEs 910 that store the first weight values of the first weight group W1 may correspond to a first PE group, and some PEs of the PEs 910 that store the second weight values of the second weight group W2 may be classified into a second PE group as elements. PEs at the boundaries of different PE groups may generate accumulation results according to MAC operation results and may perform a 1-bit shift operation on the accumulated results. The remaining PEs may perform a MAC operation. The accumulator 920 may perform the 1-bit shift operation when there is a previous accumulation result pre-stored in the accumulator 920 before performing an accumulation operation.

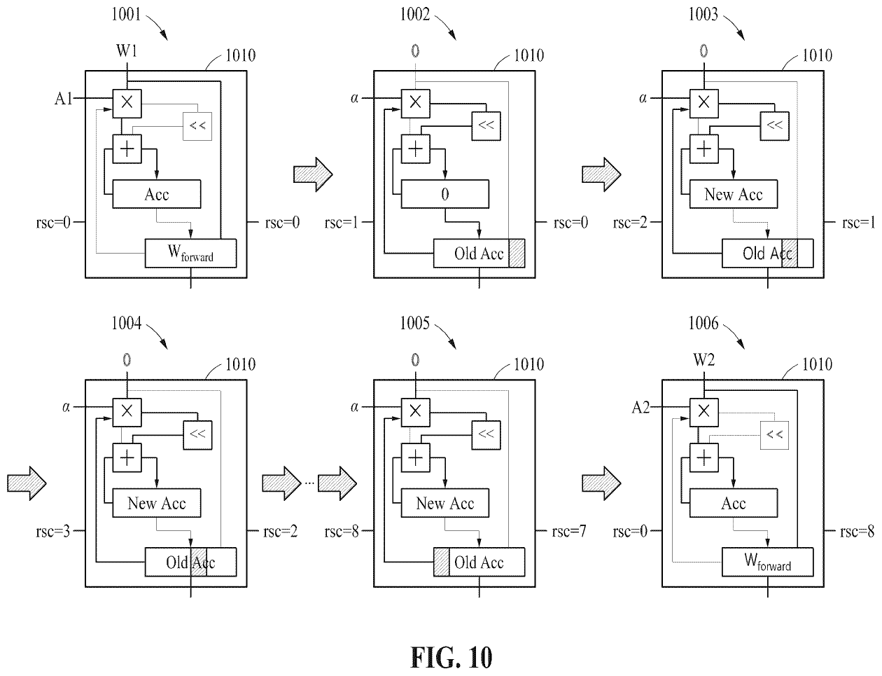

FIG. 10 is a diagram illustrating an example of a multi-bit rescaling process according to an embodiment. As described above, rescaling may be implemented using a 1-bit shifter when a ratio between scale factors is 2. FIG. 10 shows an example of implementation of multi-bit rescaling that is greater than or equal to 2.

Referring to FIG. 10, a MAC operation is performed between first activation values of a first activation group and first weight values of a first weight group and then a MAC operation may be performed between second activation values of a second activation group and second weight values of a second weight group. In FIG. 10, a first activation value A1 and a first weight value W1 may be the last input data of a first processing stage, and a second activation value A2 and a second weight value W2 may be the initial input data of a second processing stage. A ratio between scale factors of groups may be an arbitrary integer α. α may be referred to as a multiplication factor.

When a is greater than or equal to 3, unlike when a is 2, a rescaling signal rsc may sequentially increase for several cycles rather than being turned on to 1 for one cycle. For example, the rescaling signal rsc may increase using a counter but is not limited thereto. The rescaling signal rsc may increase from 1 to R. R may be determined based on a ratio between the capacity of an accumulation register Acc and the size of input data (e.g., activation values and weight values). Hereinafter, an example in which the capacity of the accumulation register Acc is 32 bits and the size of the input data is 4 bits is described, but embodiments are not limited thereto. In this case, R may be 8. In this case, the rescaling signal rsc may increase from 1 to 8 for eight cycles. A rescaling operation may be performed using a multiplier rather than a 1-bit shifter. A shifter of a PE 1010 may be an a-bit shifter rather than a 1-bit shifter.

In operation 1001, the PE 1010 may store an accumulation result in an accumulation register by performing a MAC operation between the first activation value A1 and the first weight value W1 and may forward the first activation value A1 and the first weight value W1 to the next PE. The PE 1010 may include a forward input register and a forward weight register. In FIG. 10, in operation 1001, Wforward may represent the forward weight register. In FIG. 10, an input register is omitted for convenience. Acc may represent an accumulation register.

In operation 1002, a value of the rescaling signal rsc may be set to 1 when the MAC operation is performed between the first activation value A1 and the first weight value W1 so that the MAC operation between the first activation group and the first weight group is completed. Here, a corresponding to the multiplication factor may be input to the PE 1010 instead of activation. The value stored in the accumulation register may be stored in a forward register. The lowest 4 bits of the forward register may be multiplied by a and stored in the accumulation register. Thereafter, the rescaling signal rsc may increase from 2 to 8, and meanwhile, an operation process according to Equation 1 and Equation 2 below may be repeated in operations 1003 to 1005.

$$idx = 4 \cdot Rescale\_signal \qquad Equation 1$$

$$New Acc . = New Acc . + Old Acc . [ ( idx + 4 ) : idx ] \cdot α \qquad Equation 2$$

In Equation 1, idx denotes a partial accumulation result of an accumulation result corresponding to a rescaling target. Rescale_signal denotes a value of the rescaling signal rsc. In Equation 2, New Acc. denotes a new rescaled accumulation result according to rescaling and Old Acc. denotes an existing rescaled accumulation result that is subject to rescale. In operation 1006, the second activation value A2 of the second activation group and the second weight value W2 of a second weight group W2 may be input to the PE 1010, and the PE 1010 may perform a MAC operation between the second activation value A2 and the second weight value W2.

FIG. 11 is a flowchart illustrating an example of an operation method of an accelerator, according to an embodiment. Referring to FIG. 11, in operation 1110, an accelerator may generate first MAC operation results by performing MAC operations between first quantized activation values that are quantized from first activation values of a first group in a first size range and first quantized weight values that are quantized from first weight values forming operation pairs with the first activation values. In operation 1120, the accelerator may generate first accumulation results based on the first MAC operation results. In operation 1130, the accelerator may rescale the first accumulation results based on a relationship between scale factors used to quantize an activation dataset including the first activation values and may generate first rescaled accumulation results. In operation 1140, the accelerator may generate second MAC operation results by performing MAC operations between second quantized activation values that are quantized from second activation values of a second group in a second size range and second quantized weight values that are quantized from second weight values forming operation pairs with the second activation values. In operation 1150, the accelerator may generate second accumulation results based on the first rescaled accumulation results and the second MAC operation results. In operation 1160, the accelerator may generate an operation result between the activation dataset including the first activation values and the second activation values and a weight dataset including the first weight values and the second weight values, based on the second accumulation results.

Operation 1130 may include generating the first rescaled accumulation results by multiplying the first accumulation results by a multiplication factor based on the relationship between the scale factors.

The multiplication factor may be 2, and the generating of the first rescaled accumulation results by multiplying the first accumulation results by the multiplication factor may include generating the first rescaled accumulation results by performing shift operations on the first accumulation results using 1-bit shifters.

The multiplication factor may be an integer α, and the generating of the first rescaled accumulation results by multiplying the first accumulation results by the multiplication factor may include generating the first rescaled accumulation results by performing multiplication operations between the first accumulation results and the multiplication factor using a multiplier.

The multiplication factor may correspond to a ratio between the scale factors.

The accelerator may include PEs including a multiplier configured to generate a current multiplication result by performing a multiplication operation between a current input activation value and a current input weight value, an adder configured to generate a current MAC operation result by performing an addition operation between the current multiplication result and a previous MAC operation result, an accumulation register configured to store the current MAC operation result, and a 1-bit shifter configured to perform a shift operation on an accumulation result corresponding to a final MAC operation result.

The maximum absolute value of the first activation values may be greater than the maximum absolute value of the second activation values, and a first scale factor used for quantization of the first activation values may be greater than a second scale factor used for quantization of the second activation values.

The first size range may be wider than the second size range.

The activation dataset may be an activation matrix, the first activation values and the second activation values may be different columns of the activation matrix, the weight dataset may be a weight matrix, and the first weight values and the second weight values may be different rows of the weight matrix.

The accelerator may include a systolic array.

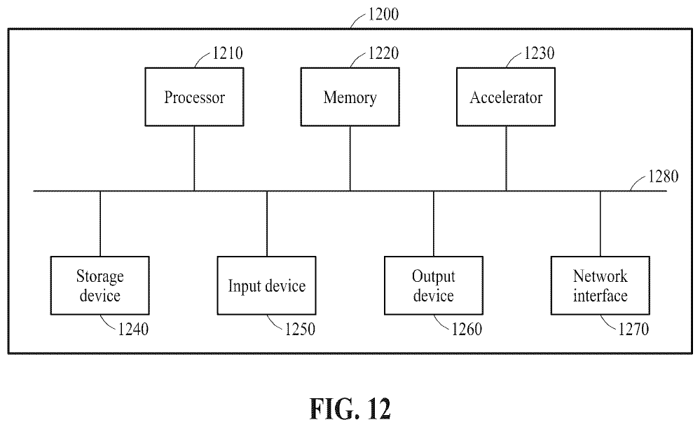

FIG. 12 is a block diagram illustrating an example of a configuration of an electronic device, according to an embodiment. Referring to FIG. 12, an electronic device 1200 may include a processor 1210, a memory 1220, an accelerator 1230, a storage device 1240, an input device 1250, an output device 1260, and a network interface 1270, which may communicate with each other via a communication bus 1280. For example, the electronic device 1200 may be implemented as at least a part of a mobile device such as a mobile phone, a smartphone, a personal digital assistant (PDA), a netbook, a tablet computer, or a laptop computer, a wearable device such as a smart watch, a smart band, or smart glasses, a computing device such as a desktop or a server, a home appliance such as a television (TV), a smart TV, or a refrigerator, a security device such as a door lock, or a vehicle such as an autonomous vehicle, or a smart vehicle.

The processor 1210 may execute instructions and functions in the electronic device 1200. For example, the processor 1210 may process instructions stored in the memory 1220 or the storage device 1240. The processor 1210 may perform the operations described with reference to FIGS. 1 to 11. The memory 1220 may include a non-transitory computer-readable storage medium or a non-transitory computer-readable storage device. The memory 1220 may store instructions that are to be executed by the processor 1210 and also store information associated with software and/or applications when the software and/or applications are being executed by the electronic device 1200.

The accelerator 1230 may include PEs configured to generate first MAC operation results by performing MAC operations between first quantized activation values that are quantized from first activation values of a first group in a first size range and first quantized weight values that are quantized from first weight values forming operation pairs with the first activation values, generate first accumulation results based on the first MAC operation results, rescale the first accumulation results based on a relationship between scale factors used to quantize an activation dataset including the first activation values and generating first rescaled accumulation results, generate second MAC operation results by performing MAC operations between second quantized activation values that are quantized from second activation values of a second group in a second size range and second quantized weight values that are quantized from second weight values forming operation pairs with the second activation values, generate second accumulation results based on the first rescaled accumulation results and the second MAC operation results, and generate an operation result between the activation dataset including the first activation values and the second activation values and a weight dataset including the first weight values and the second weight values, based on the second accumulation results.

The storage device 1240 may include a non-transitory computer-readable storage medium or a non-transitory computer-readable storage device. The storage device 1240 may store a greater amount of information than the memory 1220 and store the information for a long period of time. For example, the storage device 1240 may include magnetic hard disks, optical disks, flash memories, floppy disks, or other forms of non-volatile memories known in the art.

The input device 1250 may receive an input from a user through a traditional input scheme using a keyboard and a mouse and through a new input scheme such as a touch input, a voice input, and an image input. For example, the input device 1250 may detect an input from a keyboard, a mouse, a touchscreen, a microphone, or a user, and may include any other device configured to transfer the detected input to the electronic device 1200. For example, the input device 1250 may include a sensor such as a camera. The camera may capture a photo and/or a video. The output device 1260 may provide a user with an output of the electronic device 1200 through a visual channel, an auditory channel, or a tactile channel. The output device 1260 may include, for example, a display, a touchscreen, a speaker, a vibration generator, or any other device configured to provide a user with the output. The network interface 1270 may communicate with an external device via a wired or wireless network.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Accordingly, other implementations are within the scope of the following claims.

What is claimed is:

1. An operation method of an accelerator, the operation method comprising:
generating first multiply-accumulate (MAC) operation results by performing MAC operations between first quantized activation values that are quantized from first activation values of a first group in a first size range and first quantized weight values that are quantized from first weight values forming operation pairs with the first activation values;
generating first accumulation results based on the first MAC operation results;
rescaling the first accumulation results based on a relationship between scale factors used to quantize an activation dataset comprising the first activation values and generating first rescaled accumulation results;
generating second MAC operation results by performing MAC operations between second quantized activation values that are quantized from second activation values of a second group in a second size range and second quantized weight values that are quantized from second weight values forming operation pairs with the second activation values;
generating second accumulation results based on the first rescaled accumulation results and the second MAC operation results; and
generating an operation result between the activation dataset comprising the first activation values and the second activation values and a weight dataset comprising the first weight values and the second weight values, based on the second accumulation results.

2. The operation method of claim 1, wherein the generating of the first rescaled accumulation results comprises generating the first rescaled accumulation results by multiplying the first accumulation results by a multiplication factor based on the relationship between the scale factors.

3. The operation method of claim 2, wherein
the multiplication factor is 2, and
the generating of the first rescaled accumulation results by multiplying the first accumulation results by the multiplication factor comprises generating the first rescaled accumulation results by performing shift operations on the first accumulation results using 1-bit shifters.

4. The operation method of claim 2, wherein
the multiplication factor is an integer α, and
the generating of the first rescaled accumulation results by multiplying the first accumulation results by the multiplication factor comprises generating the first rescaled accumulation results by performing multiplication operations between the first accumulation results and the multiplication factor using a multiplier.

5. The operation method of claim 2, wherein the multiplication factor corresponds to a ratio between the scale factors.

6. The operation method of claim 1, wherein the accelerator comprises processing elements (PEs),
wherein the PEs comprise:
a multiplier configured to generate a current multiplication result by performing a multiplication operation between a current input activation value and a current input weight value;
an adder configured to generate a current MAC operation result by performing an addition operation between the current multiplication result and a previous MAC operation result;
an accumulation register configured to store the current MAC operation result; and
a 1-bit shifter configured to perform a shift operation on an accumulation result corresponding to a final MAC operation result.

7. The operation method of claim 1, wherein
a maximum absolute value of the first activation values is greater than a maximum absolute value of the second activation values, and
a first scale factor used for quantization of the first activation values is greater than a second scale factor used for quantization of the second activation values.

8. The operation method of claim 7, wherein the first size range is wider than the second size range.

9. The operation method of claim 1, wherein
the activation dataset is an activation matrix,
the first activation values and the second activation values are different columns of the activation matrix,
the weight dataset is a weight matrix, and
the first weight values and the second weight values are different rows of the weight matrix.

10. The operation method of claim 1, wherein the accelerator comprises a systolic array.

11. An accelerator comprising:
processing elements (PEs),
wherein the PEs are configured to:
generate first multiply-accumulate (MAC) operation results by performing MAC operations between first quantized activation values that are quantized from first activation values of a first group in a first size range and first quantized weight values that are quantized from first weight values forming operation pairs with the first activation values;
generate first accumulation results based on the first MAC operation results;
rescale the first accumulation results based on a relationship between scale factors used to quantize an activation dataset comprising the first activation values and generate first rescaled accumulation results;
generate second MAC operation results by performing MAC operations between second quantized activation values that are quantized from second activation values of a second group in a second size range and second quantized weight values that are quantized from second weight values forming operation pairs with the second activation values;
generate second accumulation results based on the first rescaled accumulation results and the second MAC operation results; and
generate an operation result between the activation dataset comprising the first activation values and the second activation values and a weight dataset comprising the first weight values and the second weight values, based on the second accumulation results.

12. The accelerator of claim 11, wherein the PEs are configured to generate the first rescaled accumulation results by multiplying the first accumulation results by a multiplication factor based on the relationship between the scale factors.

13. The accelerator of claim 12, wherein
the multiplication factor is 2, and
the PEs are configured to generate the first rescaled accumulation results by performing shift operations on the first accumulation results using 1-bit shifters.

14. The accelerator of claim 12, wherein
the multiplication factor is an integer α, and
the PEs are configured to generate the first rescaled accumulation results by performing multiplication operations between the first accumulation results and the multiplication factor using a multiplier.

15. The accelerator of claim 12, wherein the multiplication factor corresponds to a ratio between the scale factors.

16. The accelerator of claim 11, wherein the PEs comprise:
a multiplier configured to generate a current multiplication result by performing a multiplication operation between a current input activation value and a current input weight value;
an adder configured to generate a current MAC operation result by performing an addition operation between the current multiplication result and a previous MAC operation result;
an accumulation register configured to store the current MAC operation result; and
a 1-bit shifter configured to perform a shift operation on an accumulation result corresponding to a final MAC operation result.

17. The accelerator of claim 11, wherein
a maximum absolute value of the first activation values is greater than a maximum absolute value of the second activation values, and
a first scale factor used for quantization of the first activation values is greater than a second scale factor used for quantization of the second activation values.

18. The accelerator of claim 17, wherein the first size range is wider than the second size range.

19. The accelerator of claim 11, wherein
the activation dataset is an activation matrix,
the first activation values and the second activation values are different columns of the activation matrix,
the weight dataset is a weight matrix, and
the first weight values and the second weight values are different rows of the weight matrix.

20. The accelerator of claim 11, wherein the accelerator comprises a systolic array.
